(19) United States
(12) Patent Application Publication
(10) Pub. No.: US 2013/0230782 A1
(43) Pub. Date: Sep. 5, 2013

(54) LITHIUM BATTERY

(71) Applicant: SAMSUNG SDI CO., LTD., Yongin-si (KR)

(72) Inventor: Seung-Goo Baek, Yongin-si (KR)

(73) Assignee: SAMSUNG SDI CO., LTD., Yongin-si (KR)

(21) Appl. No.: 13/674,475

(22) Filed: Nov. 12, 2012

(30) Foreign Application Priority Data
Mar. 2, 2012 (KR) 10-2012-0022028

(51) Int. Cl. H01M 4/505; H01M 10/056; H01M 10/02

(52) U.S. Cl. CPC H01M 4/505; H01M 10/02; H01M 10/056
USPC 429/338; 429/188; 429/337; 429/342; 429/341; 429/199

(57) ABSTRACT

A lithium battery includes a cathode containing a lithium manganese oxide with a spinel structure; an anode; and an electrolyte. When stored at a temperature of about 50° C. or greater for about 7 days or longer in a charged state, the lithium manganese oxide with the spinel structure has a peak intensity ratio of the 660 cm⁻¹ peak to the 590 cm⁻¹ peak (I(660)/I(590)) in the Raman spectrum of about 0 to about 2. The electrolyte includes a mixed solvent of a high-k solvent and a low-boiling-point solvent in a volumetric ratio of from about 1:9 to about 4:6, and a lithium salt at a concentration of about 0.5M to about 2M.

### CROSS-REFERENCE TO RELATED APPLICATION

This application claims priority to and the benefit of Korean Patent Application No. 10-2012-0022028, filed on Mar. 2, 2012 in the Korean Intellectual Property Office, the entire content of which is incorporated herein by reference.

### BACKGROUND

1. Technical Field

One or more embodiments of the present invention relate to lithium batteries.

2. Description of the Related Art

In general, transition metal compounds or lithium oxides of such metal compounds (such as LiNiO₂, LiCoO₂, LiMn₂O₄, LiFePO₄, LiNiₓCo₁₋ₓO₂ (0≦x≦1), or LiNi_{1-x-y}CoₓMn_{y}O₂ (0≦x≦0.5, 0≦y≦0.5)) may be used as cathode active materials for lithium batteries.

Lithium cobalt oxide (i.e., LiCoO₂) is relatively expensive, and has a substantially limited electric capacity of about 140 mAh/g. LiCoO₂ may lose about 50% or more of the lithium at an increased charging voltage of about 4.2V or greater, and would thus be present in the battery as Li₁₋ₓCoO₂ (1>x>0.5). The lithium oxide Li₁₋ₓCoO₂ (1>x>0.5) is structurally unstable, leading to considerably reduced electric capacity of the charge/discharge cycles.

Lithium cobalt oxide compounds in which the cobalt is partially substituted with another transition metal (such as LiNiₓCo₁₋ₓO₂ (0<x<1) or LiNi_{1-x-y}CoₓMn_{y}O₂ (0≦x≦0.5, 0≦y≦0.5)) does not effectively suppress swelling at high temperatures.

Lithium manganese oxides, such as LiMn₂O₄, are inexpensive and highly stable at room temperature. Such lithium manganese oxides may be prepared by solid state reactions, molten-salt syntheses, or the like. However, lithium manganese oxides are less stable at high temperatures.

### SUMMARY

One or more embodiments of the present invention are directed to a lithium battery with improved high-temperature stability.

Additional aspects will be set forth in part in the description which follows and, in part, will be apparent from the description, or may be learned by practice of the presented embodiments.

According to one or more embodiments of the present invention, a lithium battery includes: a cathode including a lithium manganese oxide with a spinel structure; an anode; and an electrolyte. When stored at a temperature of about 50° C. or greater for about 7 days or longer in a charged state, the lithium manganese oxide with the spinel structure has a peak intensity ratio of a 660 cm⁻¹ peak to a 590 cm⁻¹ peak (I(660)/I(590)) of from about 0 to about 2 in a Raman spectrum. The electrolyte contains a mixed solvent having a high-k (i.e., a high dielectric constant) solvent and a low-boiling-point solvent in a volumetric ratio of from about 1:9 to about 4:6, and a lithium salt at a concentration of about 0.5M to about 2M.

### BRIEF DESCRIPTION OF THE DRAWINGS

These and/or other aspects will become apparent and more readily appreciated from the following description of the embodiments when taken in conjunction with the accompanying drawings in which:

FIG. 1A is a scanning electron microscopic (SEM) image of the lithium manganese oxide powder prepared in Example 1;

FIG. 1B is a magnified view of the SEM image of FIG. 1A;

FIG. 2 is a graph comparing the results of high-temperature charge/discharge tests performed on the lithium batteries manufactured in Example 6 and Comparative Example 2;

FIG. 3 is a graph comparing the Raman spectra of the lithium manganese oxides of Example 6 and Comparative Example 2 after storage at high temperature;

FIG. 4 is a cross-sectional perspective view of a lithium battery according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may be modified in different ways and should not be construed as limited to the descriptions set forth herein. Accordingly, the embodiments described below are merely exemplary and make reference to the figures to explain certain aspects of the embodiments presented in this description.

As used herein, the term “and/or” includes any and all combinations of one or more of the associated listed items. Expressions such as “at least one of,” when preceding a list of elements, modify the entire list of elements and do not modify the individual elements of the list.

Hereinafter, one or more embodiments of a lithium battery will be described in greater detail.

According to an embodiment of the present invention, a lithium battery includes: a cathode containing a lithium manganese oxide with a spinel structure; an anode; and an organic electrolyte solution. When stored at a temperature of about 50° C. or greater for about 7 days or longer in a charged state, the lithium manganese oxide with the spinel structure has a peak intensity ratio of a 660 cm⁻¹ peak to a 590 cm⁻¹ peak (I(660)/I(590)) of from about 0 to about 2 in a Raman spectrum. The organic electrolyte solution includes a mixed solvent of a high-k (i.e., a high dielectric constant) solvent and a low-boiling-point solvent in a volumetric ratio of from about 1:9 to about 4:6, and a lithium salt at a concentration of about 0.5M to about 2M.

Existing lithium manganese oxides have a relatively high intensity ratio of the 660 cm⁻¹ peak to the 590 cm⁻¹ peak of about 3 or greater in a Raman spectrum when left at high temperatures for a long time after being charged. The relatively high peak intensity at 660 cm⁻¹ is attributed to the generation of a new phase arising from deterioration of the charged lithium manganese oxide.

However, the lithium manganese oxide according to embodiments of the present invention has an intensity ratio of the 660 cm⁻¹ peak to the 590 cm⁻¹ peak of about 2 or less, and the two peaks have similar intensities. This indicates suppression of the generation of the new phase arising from the deterioration of the lithium manganese oxide. Therefore, the lithium manganese oxide according to embodiments of the present disclosure is less likely to deteriorate even when left at high temperatures after charging, and thus may contribute to the high-temperature stability of the lithium battery.

In the lithium battery according to embodiments of the present disclosure, the inclusion of an organic electrolyte solution having a high-k solvent and a low-boiling-point solvent mixed in a volumetric ratio of about 1:9 to about 4:6 may also contribute to the high-temperature stability of the lithium battery. The k referred to in the “high-k solvent” means the dielectric constant. When the mixing ratio of the high-k solvent to the low-boiling-point solvent is less than about 1:9, the amount of the high-k solvent may be so small that a lithium salt may precipitate. When the mixing ratio of the high-k solvent to the low-boiling-point solvent is greater than about 4:6, the amount of the high-k solvent may be excessively high, leading to deterioration in the mobility and conductivity of lithium ions.

For example, when stored at a temperature of about 50° C. or greater for about 7 days or longer in a charged state, the lithium manganese oxide with the spinel structure may have a peak intensity ratio of the 660 cm⁻¹ peak to the 590 cm⁻¹ peak (I(660)/I(590)) of about 0 to about 2 in the Raman spectrum. In some embodiments, the peak intensity ratio (I(660)/I(590)) may be about 0.1 to about 1.5. When the peak intensity ratio (I(660)/I(590)) is within these ranges, further improved high-temperature stability and lifetime characteristics may be obtained.

The lithium manganese oxide may have a peak area ratio of the 660 cm⁻¹ peak to the 590 cm⁻¹ peak (A(660)/A(590)) of about 0 to about 2 in the Raman spectrum. In some embodiments, the peak area ratio (A(660)/A(590)) may be about 0.1 to about 1.5. When the peak area ratio is within these ranges, further improved high-temperature stability and lifetime characteristics may be obtained.

The lithium manganese oxide may have an average primary particle diameter of about 1 to about 3 μm. When the average primary particle diameter is within this range, further improved high-temperature stability and lifetime characteristics may be obtained. The primary particles may be spherical.

The lithium manganese oxide may have an average secondary particle diameter (D50) of about 10 to about 20 μm. The secondary particles are agglomerates of a plurality of primary particles. The average secondary particle diameter (D50) can be measured using a laser particle size analyzer. When the average secondary particle diameter is within the above range, further improved high-temperature stability and lifetime characteristics may be obtained.

In some embodiments, the lithium manganese oxide may have a specific surface area of about 0.2 m²/g to about 0.4 m²/g. The specific surface area may be determined using a Brunauer-Emmett-Teller (BET) equation based on the amount of adsorbed nitrogen measured in a nitrogen adsorption test. When the specific surface area is within the above range, further improved high-temperature stability and lifetime characteristics may be obtained.

The lithium manganese oxide according to embodiments of the present disclosure may be represented by Formula 1 below.

LiₓMn_{2-y-z}M_{y}Me_{z}O₄₋ₐFₐ Formula 1

In Formula 1 above, 0.9≦x≦1.4, 0≦y≦1, 0≦z≦1, 0≦y+z≦1, and 0≦a≦1; M may be at least one metal selected from aluminum (Al), cobalt (Co), nickel (Ni), chromium (Cr), iron (Fe), zinc (Zn), magnesium (Mg), or lithium (Li); and Me may be boron (B) or vanadium (V).

In some embodiments, the lithium manganese oxide may be represented by Formula 2 below.

Li_{x+z}Mn_{2-y-z}Al_{y}O₄ Formula 2

In Formula 2, 0.6≦x≦1.4, 0≦z≦1, and 0≦d≦1.

For example, the lithium manganese oxide may be LiMn₂O₄, or Li_{a+c}Mn_{2-b-c}Al_{b}O₄ where 0.9≦a+c≦1.2, and 0≦b≦0.2.

The cathode of the lithium battery may further include a lithium composite oxide represented by Formula 3 below.

Li[LiₓMe_{y}M′_{z}]O_{2+d} Formula 3

In Formula 3 above, x+y+z=1, 0≦x<0.33, 0≦z≦0.15, and 0≦c≦1; Me may be at least one element selected from manganese (Mn), vanadium (V), chromium (Cr), iron (Fe), cobalt (Co), nickel (Ni), aluminum (Al), or boron (B); and M′ is at least one element selected from boron (B), aluminum (Al), magnesium (Mg), silicon (Si), iron (Fe), vanadium (V), chromium (Cr), copper (Cu), zinc (Zn), gallium (Ga), and tungsten (W).

In some other embodiments, the cathode may further include a lithium composite oxide represented by Formula 4 below.

LiₐCo_{b}Mn_{c}M_{d}Ni_{1-(b+c+d)}O_{2+d} Formula 4

In Formula 4 above, 1≦a≦1.33, 0.1≦b≦0.5, 0.05≦c≦0.4, 0.01≦c≦0.4, and 0.05≦b+c+d≦0.5; and M may be at least one element selected from boron (B), aluminum (Al), magnesium (Mg), silicon (Si), iron (Fe), vanadium (V), chromium (Cr), copper (Cu), zinc (Zn), gallium (Ga), or tungsten (W).

The high-k solvent of the electrolyte in the lithium battery may be at least one selected from ethylene carbonate, propylene carbonate, butylene carbonate, or γ-butyrolactone, but is not limited thereto, and may be any high-k solvent used in the art.

The low-boiling-point solvent of the electrolyte in the lithium battery may be at least one selected from dimethyl carbonate, ethylmethyl carbonate, diethyl carbonate, dipropyl carbonate, dimethoxyethane, diethoxyethane, or fatty acid ester derivatives, but is not limited thereto, and may be any low-boiling-point solvent used in the art.

The lithium salt of the lithium battery may be at least one selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are each independently a natural number), LiCl, LiI, or a mixture thereof, but is not limited thereto, and may be any lithium salt used in the art.

The anode of the lithium battery may include a carbonaceous material. The carbonaceous material may be graphite powder, but is not limited thereto, and may be any carbonaceous material used as an anode active material in the art.

The lithium battery may be manufactured as follows.

First, the cathode may be prepared as follows. For example, the cathode may be manufactured by molding a cathode active material composition (including a cathode active material and a binder) into a desired shape, or by coating the cathode active material composition on a current collector (such as a copper foil, aluminum foil, or the like).

The cathode active material may include the lithium manganese oxide having the spinel structure described above. The cathode active material may further include any one or more of the lithium composite oxides represented by Formulae 3 and 4 above.

In particular, the cathode active material, a conducting agent, a binder, and a solvent are mixed to prepare the cathode active material composition. The cathode active material composition may be directly coated on a metallic current collector to prepare a cathode plate. Alternatively, the cathode active material composition may be cast on a separate support to form a cathode active material film, which film may then be separated from the support and laminated on the metallic current collector to prepare a cathode plate. The cathode is not limited to the examples described above, and may be one of a variety of different types.

The conducting agent may be carbon black or graphite particulates, but is not limited thereto. Any material used as a conducting agent in the art may be used.

Nonlimiting examples of the binder include vinylidene fluoride/hexafluoropropylene copolymers, polyvinylidene fluoride (PVDF), polyacrylonitrile, polymethylmethacrylate, polytetrafluoroethylene, styrene butadiene rubber polymers, and mixtures thereof. However, any material used as a binding agent in the art may be used.

Nonlimiting examples of the solvent include N-methyl-pyrrolidone, acetone, and water. However, any material used as a solvent in the art may be used.

The amounts of the cathode electrode active material, the conducting agent, the binder, and the solvent used in the manufacture of the lithium battery are those levels that are generally used in the art. At least one of the conducting agent, the binder and the solvent may be omitted depending on the desired use and structure of the lithium battery.

Next, the anode is prepared as follows. For example, an anode active material, a conducting agent, a binder, and a solvent are mixed to prepare an anode active material composition. The anode active material composition is directly coated on a metallic current collector and dried to prepare an anode plate. Alternatively, the anode active material composition may be cast on a separate support to form an anode active material film, which film may then be separated from the support and laminated on the metallic current collector to prepare the anode plate.

The anode active material may be a carbonaceous material as described above, but is not limited thereto, and may be any anode active material used in the art. For example, the anode active material may include at least one selected from lithium metal, metals alloyable with lithium, transition metal oxides, non-transition metal oxides, and carbonaceous materials.

Nonlimiting examples of metals alloyable with lithium include Si, Sn, Al, Ge, Pb, Bi, Sb, Si—Y alloys (where Y is an alkali metal, an alkali earth metal, a Group XIII element, a Group XIV element, a transition metal, a rare earth element, or a combination thereof, except that Y is not Si), and Sn—Y alloys (where Y is an alkali metal, an alkali earth metal, a Group XIII element, a Group XIV element, a transition metal, a rare earth element, or a combination thereof, except that Y is not Sn). Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof.

Nonlimiting examples of the transition metal oxide include lithium titanium oxides, vanadium oxides, and lithium vanadium oxides.

Nonlimiting examples of the non-transition metal oxide include SnO₂ and SiOₓ (0<x<2).

Nonlimiting examples of the carbonaceous material include crystalline carbon, amorphous carbon, and mixtures thereof. Nonlimiting examples of the crystalline carbon include graphite, such as natural graphite or artificial graphite that may be amorphous, plate-shaped, flake-shaped, spherical or fibrous. Nonlimiting examples of the amorphous carbon include soft carbon (i.e., carbon sintered at low temperatures), hard carbon, meso-phase pitch carbides, sintered cokes, and the like.

The conducting agent, the binder and the solvent used for the anode active material composition may be the same as those used for the cathode active material composition. Also, a plasticizer may be further added into the cathode active material composition and/or the anode active material composition to form pores in the electrode plates.

The amounts of the anode active material, the conducting agent, the binder, and the solvent are those levels that are generally used to manufacture a lithium battery. At least one of the conducting agent, the binder and the solvent may be omitted depending on the desired use and structure of the lithium battery.

Next, a separator is prepared. The separator is disposed between the cathode and the anode. The separator may be any separator that is commonly used in lithium batteries. The separator may have low resistance to the migration of ions in an electrolyte, and have good electrolyte-retaining ability. Nonlimiting examples of the separator include glass fibers, polyester, Teflon, polyethylene, polypropylene, polytetrafluoroethylene (PTFE), and combinations thereof, each of which may be a non-woven or woven fabric. For example, a rollable separator including polyethylene or polypropylene may be used in a lithium ion battery. A separator with good organic electrolyte-retaining ability may be used in a lithium ion polymer battery. For example, the separator may be manufactured in the following manner.

A polymer resin, a filler, and a solvent may be mixed together to prepare a separator composition. Then, the separator composition may be directly coated on an electrode, and then dried to form the separator. Alternatively, the separator composition may be cast on a support and then dried to form a separator film, which film may then be separated from the support and laminated on the electrode to form the separator.

The polymer resin used in manufacturing the separator may be any material that is commonly used as a binder for electrode plates. Nonlimiting examples of the polymer resin include vinylidenefluoride/hexafluoropropylene copolymers, polyvinylidene fluoride (PVDF), polyacrylonitrile, polymethylmethacrylate, and mixtures thereof.

Next, an electrolyte is prepared. For example, the electrolyte may be prepared by dissolving a lithium salt in a mixed solvent of a high-k solvent and a low-boiling-point solvent. The electrolyte may be an organic electrolyte solution containing a mixed solvent of a high-k solvent and a low-boiling-point solvent in a volumetric ratio of about 1:9 to about 4:6, and a lithium salt at a concentration of about 0.5M to about 2M.

The high-k solvent may be at least one selected from ethylene carbonate, propylene carbonate, butylene carbonate, or γ-butyrolactone, but is not limited thereto, and may be any solvent known in the art to have a high dielectric constant (k).

The low-boiling-point solvent may be at least one selected from dimethyl carbonate, ethylmethyl carbonate, diethyl carbonate, dipropyl carbonate, dimethoxyethane, diethoxyethane, or fatty acid ester derivatives, but is not limited thereto, and may be any solvent known in the art to have a low boiling point.

The lithium salt may be at least one selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are each independently a natural number), LiCl, LiI, or mixtures thereof, but is not limited thereto, and may be any lithium salt used in the art.

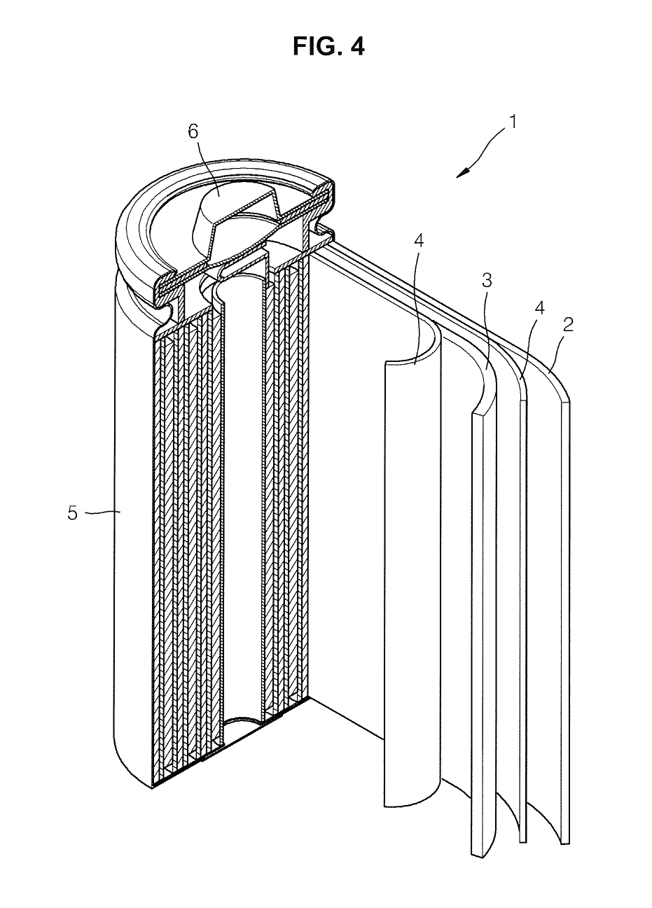

Referring to FIG. 4, a lithium battery 1 includes a cathode 3, an anode 2, and a separator 4. The cathode 3, the anode 2 and the separator 4 are wound or folded, and then sealed in a battery case 5. Then, the battery case 5 is filled with an organic electrolyte solution and sealed with a cap assembly 6, thereby completing the manufacture of the lithium battery 1. The battery case 5 may be a cylindrical case, a rectangular case, or a thin-film case. For example, the lithium battery may be a thin-film battery. The lithium battery may be a lithium ion battery.

The separator may be disposed between the cathode and the anode to form a battery assembly. Alternatively, the battery assembly may be stacked in a bi-cell structure and impregnated with the electrolyte solution. The resultant is put into a pouch and hermetically sealed, thereby completing the manufacture of a lithium ion polymer battery.

Alternatively, a plurality of battery assemblies may be stacked to form a battery pack, which may be used in any device that operates at high temperatures and requires high output, for example, a laptop computer, a smart phone, electric vehicle, or the like.

### EXAMPLES

Hereinafter, one or more embodiments of the present invention will be described with reference to the following examples. However, these examples are not intended to limit the scope of the present invention.

### Preparation of Cathode Active Material

### Example 1

Electrolytic manganese oxide (MnO₂) powder was ground using a wet grinder to an average particle diameter of about 0.5 μm, followed by addition of an aqueous solution of lithium hydroxide to reach an atomic ratio of lithium to manganese of about 0.54:1. Thereafter, aluminum hydroxide was added thereto while stirring, thereby obtaining a slurry with a 20% solids content. The slurry was dried using a spray dryer with the following operation conditions: hot-air inlet temperature of about 300˜310° C.; and hot-air outlet temperature of about 110˜150° C. The dried slurry was sintered in a rotary kiln in air at about 850° C. for about 6 hours to obtain a lithium manganese oxide (i.e., Li_{1.08}Mn_{1.84}Al_{0.08}O_{3.99}) having a spinel structure.

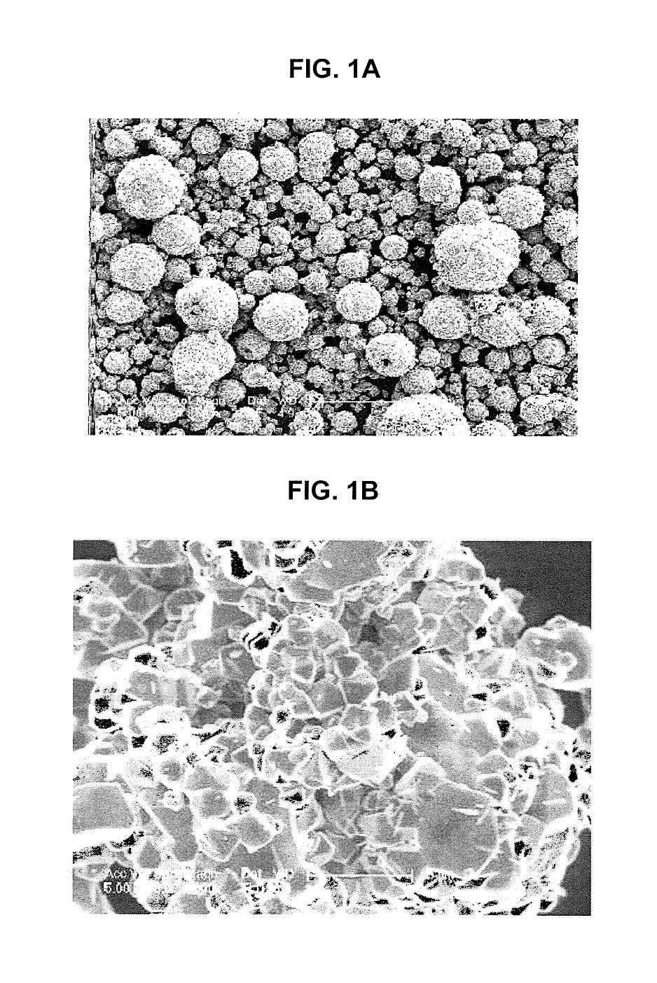

The resulting lithium manganese oxide had an average primary particle diameter of about 1˜3 μm. Scanning electron microscopic (SEM) images of the lithium manganese oxide prepared in Example 1 are shown in FIGS. 1A and 1B.

### Example 2

A cathode active material was prepared in the same manner as in Example 1, except that the atomic ratio of Li to Mn was varied to about 0.57:1.

### Example 3

A cathode active material was prepared in the same manner as in Example 1, except that the atomic ratio of Li to Mn was varied to about 0.51:1.

### Example 4

A cathode active material was prepared in the same manner as in Example 1, except that the atomic ratio of Li to Mn was varied to about 0.60:1.

### Example 5

The lithium manganese oxide of Example 1 and LiNi_{1/3}CO_{1/3}Mn_{1/3}O₂ were blended in a 1:1 mole ratio to prepare a cathode active material.

### Comparative Example 1

Commercially available LiMn₂O₄ (type G, available from Mitsui) was used as a cathode active material.

### Manufacture of Anode and Lithium Battery

### Example 6

The cathode active material powder of Example 1 and a carbonaceous conducting agent (Ketjen Black, EC-600JD) were uniformly mixed in a weight ratio of about 80:10, and then a polyvinylidene fluoride (PVDF) binder solution was added thereto to prepare a slurry containing the cathode active material, the carbonaceous conducting agent, and the binder in a weight ratio of about 80:10:10. The slurry was coated on a 15 μm-thick aluminum foil and then dried to form a cathode plate. Then, the cathode plate was further dried under vacuum.

To manufacture an anode, graphite powder and a carbonaceous conducting agent (Ketjen Black, EC-600JD) were uniformly mixed in a weight ratio of about 80:10, and then a polyvinylidene fluoride (PVDF) binder solution was added thereto to prepare a slurry containing the anode active material, the carbonaceous conducting agent, and the binder in a weight ratio of about 80:10:10. The slurry was coated on a 15 μm-thick copper foil and then dried to form an anode plate. Then, the anode plate was further dried under vacuum to manufacture a coin cell having a diameter of about 12 mm.

A polypropylene separator, and an electrolyte including 1.0M LiPF₆ dissolved in a mixed solvent of ethylenecarbonate (EC) and ethylmethylcarbonate (EMC) in a 3:7 volume ratio were used.

### Example 7

A lithium battery was manufactured in the same manner as in Example 6, except that the cathode active material powder of Example 2 was used.

### Example 8

A lithium battery was manufactured in the same manner as in Example 6, except that the cathode active material powder of Example 3 was used.

### Example 9

A lithium battery was manufactured in the same manner as in Example 6, except that the cathode active material powder of Example 4 was used.

### Example 10

A lithium battery was manufactured in the same manner as in Example 6, except that the cathode active material powder of Example 5 was used.

### Comparative Example 2

A lithium battery was manufactured in the same manner as in Example 6, except that the cathode active material of Comparative Example 1 was used.

### Evaluation Example 1

### Measurement of Brunauer-Emmett-Teller (BET) Specific Surface Area

The BET specific surface areas of the cathode active material powders of Examples 1-5 and Comparative Example 1 were measured. The results are shown in part in Table 1 below.

TABLE 1

| | Specific surface area [m²/g] |
|---|---|
| Example 1 | 0.30 |
| Comparative Example 1 | 0.18 |

Referring to Table 1, the cathode active material of Example 1 was found to have a larger specific surface area than the cathode active material of Comparative Example 1.

### Evaluation Example 2

### Measurement of Average Particle Diameter (D50)

The average particle diameters (D50) of the secondary particles (on a volume basis) of the cathode active material powders of Examples 1-5 and Comparative Example 1 were measured. The results are shown in part in Table 2 below. The secondary particles refer to agglomerates of a plurality of primary particles.

TABLE 2

| | Average particle diameter |
|---|---|
| | of secondary particles |
| | (D50) [μm] |
| Example 1 | 16.17 |
| Comparative Example 1 | 24.80 |

Referring to Table 2, the cathode active material of Example 1 was found to have a smaller average particle diameter of the secondary particles than that of Comparative Example 1.

### Evaluation Example 3

### Evaluation of High-Temperature Lifetime Characteristics

The coin cells of Examples 7-12 and Comparative Examples 4-6 were each subjected to one charge-discharge cycle at 25° C. and a constant current rate of 0.1 C in a voltage range of from about 3.6V to about 4.3V with respect to lithium metal (Formation process).

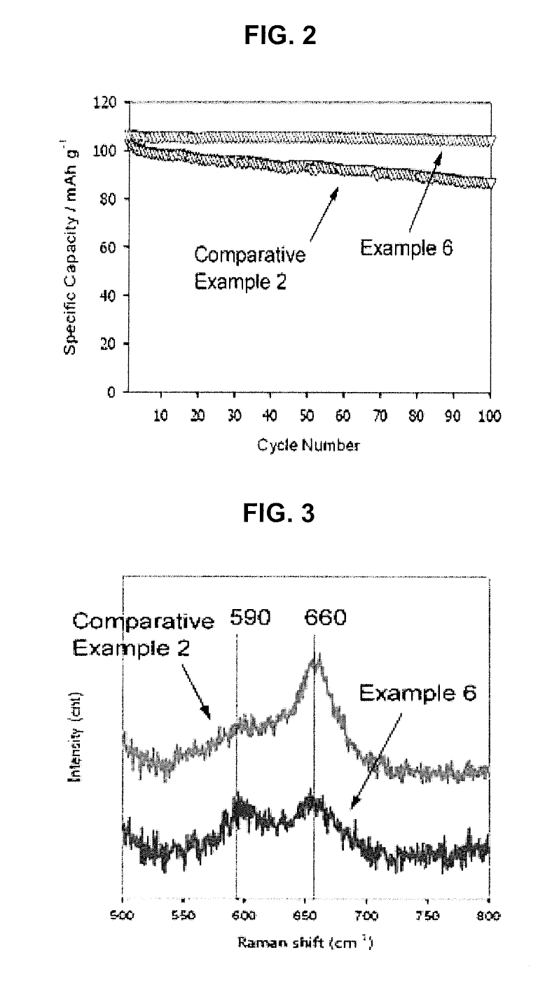

After undergoing the formation process, each of the lithium batteries was subjected to one charge-discharge cycle at about 25° C. and a constant current rate of 0.2 C in a voltage range of about 3.6V to about 4.3V with respect to lithium metal (Standard charge/discharge process). Then, each lithium battery was subjected to one hundred charge-discharge cycles at about 60° C. and a constant current rate of 0.2 C in a voltage range of from about 3.6V to about 4.3V with respect to lithium metal. The results are shown in part in Table 3 below and FIG. 2. The capacity retention rate was calculated by Equation 1 below.

Capacity retention rate (%)=Discharge capacity at 100^{th} cycle/Discharge capacity at 1^{st} cycle×100 Equation 1

TABLE 3

| | Capacity retention rate [%] |
|---|---|
| Example 6 | 98.2 |
| Comparative Example 2 | 85.4 |

Referring to Table 3, the lithium battery of Example 6 was found to have better high-temperature lifetime characteristics than those Comparative Example 2.

### Evaluation Example 4

### Raman Spectrum Measurement

The coin cells of Examples 6-10 and Comparative Example 2 were each subjected to two charge-discharge cycles at about 25° C. and a constant current rate of 0.1 C in a voltage range of about 3V to about 4.3V with respect to lithium metal (Formation process).

After undergoing the formation process, each of the lithium batteries was charged at about 25° C. and a constant current rate of 0.2 C to a voltage of 4.3V with respect to lithium metal (1^{st} charging), and then stored in a 60° C. oven for 7 days. After disassembling the lithium batteries, Raman spectra of the cathode active materials of the lithium batteries were measured. The results are shown in part in FIG. 2.

A 3D confocal Raman Microscopy System (Nanofinder 30, Tokyo Instruments, Inc) was used in the Raman spectrum measurement in which a 488 nm diode laser light source and a 100× magnification optical lens were used, and the exposure time was set to 5 seconds.

Referring to FIG. 3, the cathode active material obtained from the lithium battery of Example 6 was found to exhibit similar peak intensities at 590 cm⁻¹ and 660 cm⁻¹, while the lithium battery of Comparative Example 2 exhibited a peak intensity at 660 cm⁻¹ that was about 3 times (or more) higher than the peak intensity at 590 cm⁻¹.

In other words, in the lithium battery of Comparative Example 2, the peak intensity at 590 cm⁻¹ was significantly lower, and the peak intensity at 660 cm⁻¹ was significantly higher, than those of the lithium battery of Example 6. This indicates that a considerable structural change occurred in the lithium manganese oxide of the lithium battery of Comparative Example 2.

Referring to FIG. 3, the cathode active material obtained from the lithium battery of Example 6 was found to exhibit similar peak areas at 590 cm⁻¹ and 660 cm⁻¹, while the lithium battery of Comparative Example 2 exhibited a peak area at 660 cm⁻¹ that was 5 times (or more) larger than the peak area at 590 cm⁻¹.

### Evaluation Example 5

### High-Temperature Stability Evaluation

The coin cells of Examples 6-12 and Comparative Examples 2-6 were each subjected to one charge-discharge cycle at 25° C. and a constant current rate of 0.1 C in a voltage range of about 3.6V to about 4.3V with respect to lithium metal (Formation process).

After undergoing the formation process, each of the lithium batteries was charged at about 25° C. and a constant current rate of 0.2 C to a voltage of 4.3V with respect to lithium metal (1^{st} charging), and then discharged at a constant current rate of 0.2 C rate to a voltage of 3.6V (Standard charge-discharge cycle, 1^{st} cycle). The discharge capacity at the 1^{st} cycle was assumed as the standard capacity of each battery.

Subsequently, each lithium battery was charged at a constant current rate of 0.1 C to a voltage of about 4.3V with respect to lithium metal, and then stored in a 60° C. oven for about 7 days. Afterward, each lithium battery was discharged at about 25° C. and a constant current rate of 0.1 C to a voltage of about 3.6V with respect to lithium metal (2^{nd} discharging).

Next, each lithium battery was charged at about 25° C. and a constant current rate of 0.2 C to a voltage of 4.3V with respect to lithium metal (3^{rd} charging), and then discharged at a constant current rate of 0.1 C to a voltage of 3.6V (3^{rd} discharging).

Subsequently, the charge-discharge cycle conditions of the 3^{rd} cycle were repeated 100 times.

The results of the charge-discharge cycles are shown in part in Table 4 below. The recovery ratio was calculated using Equation 2 below, and the capacity retention rate was calculated using Equation 3 below.

Recovery ratio (%)=Discharge capacity at 3^{rd} cycle/Discharge capacity at 1^{st} cycle (Standard capacity)×100 Equation 2

Capacity retention rate (%)=[Discharge capacity at 100^{th} cycle/Discharge capacity at 1^{st} cycle]×100 Equation 3

TABLE 4

| | | Capacity retention rate |
|---|---|---|
| | Recovery ratio [%] | [%] |
| Example 6 | 86.0 | 98.2 |
| Comparative Example 2 | 70.2 | 85.4 |

Referring to Table 4, the lithium battery of Example 6 was found to have better high-temperature stability and high-temperature lifetime characteristics (capacity retention rate after high-temperature storage) than the lithium battery of Comparative Example 2.

As described above, according to one or more embodiments of the present invention, using a lithium manganese oxide having the specific physical characteristics and an organic electrolyte solution having the specific composition in a lithium battery leads to improved high-temperature stability and high-temperature lifetime characteristics.

While certain exemplary embodiments have been illustrated and described therein, the present invention is not limited to those embodiments, and those of ordinary skill in the art will recognize that certain modifications and changes to the described embodiments may be made without departing from the spirit and scope of the present invention, as defined in the following claims. Also, descriptions of features or aspects of certain embodiments should typically be considered as available for other similar features or aspects of other embodiments.

What is claimed is:

1. A lithium battery comprising:
a cathode including a lithium manganese oxide having a spinel structure;
an anode; and
an electrolyte comprising a mixed solvent of a high-k solvent and a low-boiling-point solvent in a volumetric ratio of from about 1:9 to about 4:6, and a lithium salt at a concentration of about 0.5M to about 2M,
wherein, when stored at a temperature of about 50° C. or greater for about 7 days or longer in a charged state, the lithium manganese oxide has a peak intensity ratio of a 660 cm⁻¹ peak to a 590 cm⁻¹ peak (I(660)/I(590)) in a Raman spectrum of about 0 to about 2.

2. The lithium battery of claim 1, wherein the peak intensity ratio of the 660 cm⁻¹ peak to the 590 cm⁻¹ peak (I(660)/I(590)) is about 0 to about 1.5.

3. The lithium battery of claim 1, wherein when stored at a temperature of about 50° C. or greater for about 7 days or longer in a charged state, the lithium manganese oxide has a peak area ratio of the 660 cm⁻¹ peak to the 590 cm⁻¹ peak (A(660)/A(590)) in the Raman spectrum of about 0 to about 2.

4. The lithium battery of claim 1, wherein the lithium manganese oxide has an average primary particle diameter of about 1 to about 3 μm.

5. The lithium battery of claim 1, wherein the lithium manganese oxide has an average secondary particle diameter (D50) of about 10 to about 20 μm.

6. The lithium battery of claim 1, wherein the lithium manganese oxide has a specific surface area of about 0.2 m²/g to about 0.4 m²/g.

7. The lithium battery of claim 1, wherein the lithium manganese oxide is represented by Formula 1:
LiₓMn_{2-y-z}M_{y}Me_{z}O₄₋ₐFₐ Formula 1
wherein, 0.9≦x≦1.4, 0≦y≦1, 0≦z≦1, 0≦y+z≦1, and 0≦a≦1;
M is at least one metal selected from the group consisting of aluminum (Al), cobalt (Co), nickel (Ni), chromium (Cr), iron (Fe), zinc (Zn), magnesium (Mg), and lithium (Li); and
Me is boron (B) or vanadium (V).

8. The lithium battery of claim 1, wherein the lithium manganese oxide is represented by Formula 2:
Li_{x+z}Mn_{2-y-z}Al_{y}O₄ Formula 2
wherein, 0.9≦x≦1.4, 0≦y≦1, and 0≦z≦1.

9. The lithium battery of claim 1, wherein the cathode further comprises a lithium composite oxide represented by Formula 3:
Li[LiₓMe_{y}M′_{z}]O_{2+d} Formula 3
wherein, x+y+z=1, 0≦x<0.33, 0≦z≦0.15, and 0≦d≦0.1;
Me is at least one element selected from the group consisting of manganese (Mn), vanadium (V), chromium (Cr), iron (Fe), cobalt (Co), nickel (Ni), aluminum (Al), and boron (B); and
M′ is at least one element selected from the group consisting of boron (B), aluminum (Al), magnesium (Mg), silicon (Si), iron (Fe), vanadium (V), chromium (Cr), copper (Cu), zinc (Zn), gallium (Ga), and tungsten (W).

10. The lithium battery of claim 1, wherein the cathode further comprises a lithium composite oxide represented by Formula 4:
LiₐCo_{b}Mn_{c}M_{d}Ni_{1-(b+c+d)}O_{2+d} Formula 4
wherein, 1≦a≦1.33, 0.1≦b≦0.5, 0.05≦c≦0.4, 0.01≦d≦0.4, and 0.05≦b+c+d≦0.5; and
M is at least one element selected from the group consisting of boron (B), aluminum (Al), magnesium (Mg), silicon (Si), iron (Fe), vanadium (V), chromium (Cr), copper (Cu), zinc (Zn), gallium (Ga), and tungsten (W).

11. The lithium battery of claim 1, wherein the high-k solvent is at least one selected from the group consisting of ethylene carbonate, propylene carbonate, butylene carbonate, and γ-butyrolactone.

12. The lithium battery of claim 1, wherein the low-boiling-point solvent is at least one selected from the group consisting of dimethyl carbonate, ethylmethyl carbonate, diethyl carbonate, dipropyl carbonate, dimethoxyethane, diethoxyethane, and fatty acid ester derivatives.

13. The lithium battery of claim 1, wherein the lithium salt is selected from the group consisting of LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) wherein x and y are each independently a natural number, LiCl, LiI, and mixtures thereof.

14. The lithium battery of claim 1, wherein the anode comprises a carbonaceous material.
